(19) United States
(12) Patent Application Publication
(10) Pub. No.: US 2026/0236022 A1
(43) Pub. Date: Aug. 13, 2026

(54) VEHICLE CONTROL SYSTEM AND VEHICLE CONTROL METHOD

(71) Applicants: HYUNDAI MOTOR COMPANY, SEOUL (KR); KIA CORPORATION, SEOUL (KR)

(72) Inventor: Qi Yuan Wang, Shandong (CN)

(73) Assignees: HYUNDAI MOTOR COMPANY, SEOUL (KR); KIA CORPORATION, SEOUL (KR)

(21) Appl. No.: 19/532,467

(22) Filed: Feb. 6, 2026

(30) Foreign Application Priority Data
Feb. 8, 2025 (CN) 202510144689.3

(51) Int. Cl. G05D 1/2285; G01S 13/88; G05D 109/10; G05D 111/30

(52) U.S. Cl. CPC G05D 1/2285; G01S 13/88; G05D 2109/10; G05D 2111/30

(57) ABSTRACT

A vehicle control system and method are disclosed. The vehicle control system includes a radar and a main control device. The radar includes a radar processing module and a plurality of radars, the radar processing module being communicatively connected to the plurality of radars. The plurality of radars collect radar signals within a predetermined range around the vehicle and transmit the collected radar signals to the radar processing module, and the radar processing module recognizes a user's gesture based on the collected radar signals. The main control device is communicatively connected to the radar. When the vehicle is unattended, the main control device determines whether the user's gesture is recognized within the predetermined range of the vehicle, determines a corresponding function based on the recognized user's gesture, executes the determined corresponding function, and provides an execution result to the user as feedback.

### CROSS REFERENCE TO RELATED APPLICATIONS

This application claims priority to, and the benefit of, Chinese Patent Application No. 202510144689.3 filed with the Chinese National Intellectual Property Administration on Feb. 8, 2025, the entire contents of which are incorporated herein by reference.

### TECHNICAL FIELD

The present disclosure relates to the field of vehicle control technology and particularly relates to a vehicle control system and method.

### BACKGROUND

Advances in vehicle electronics technology have enabled many new interactive technologies, such as voice interaction and touchscreen gesture interaction. These technologies enable users to interact more conveniently with vehicles, improving the user's convenience and stability.

Conventional gesture interactive technology mainly captures the user's gestures using various sensors and cameras in the vehicle, then recognizes these gestures through algorithms and operates a function application based on the recognition results. These conventional gesture interactive technologies focus on interactivity within the vehicle and do not cover gesture recognition and response outside the vehicle.

Therefore, to provide a more comfortable and personalized driving experience, research on a control system and method for recognizing and responding to the user's gestures outside the vehicle, predicting the user's intentions, and automatically executing corresponding operations is needed.

The information contained in this background section is intended to enhance understanding of the background of the disclosure and may include matters that are not conventional art that would already be known to a person of ordinary skill in the field to which this technology belongs.

### SUMMARY

The present disclosure provides a vehicle control system and a method for recognizing a user's position using radars of the vehicle, recognizing the user's specific gesture using point-cloud signal gesture recognition, and implementing a functional response in a non-contact manner when the vehicle is unattended.

An example embodiment of the present disclosure provides a vehicle control system. The system includes a radar and a main control device, wherein the radar includes a radar processing module and a plurality of radars, the radar processing module is communicatively connected to each of the plurality of radars, the plurality of radars collects radar signals within a predetermined range around the vehicle and transmit received radar signals to the radar processing module, the radar processing module recognizes a user's gesture based on the received radar signals, the main control device is communicatively connected to the radar, and when the vehicle is unattended, the main control device is configured to determine whether the user's gesture is recognized within the predetermined range of the vehicle, determine a corresponding function based on the recognized user's gesture, execute the determined corresponding function, and provide an execution result to the user as feedback.

The main control device may be further configured to detect whether the vehicle is unlocked, determine that the vehicle is unattended when the vehicle is detected as unlocked, detect whether a car key exists within a predetermined range of the vehicle, detect whether a gear of the vehicle is a neutral gear N or a parking gear P, and may determine whether the user's gesture is recognized within the predetermined range of the vehicle when the vehicle is unattended, the car key exists within a predetermined range of the vehicle, and the gear of the vehicle is determined as the neutral gear N or the parking gear P.

The main control device may include a storage device, the storage device stores a mapping table including predetermined gesture information and corresponding functions, the main control device may be further configured to determine the corresponding function based on the recognized user's gesture according to the mapping table including predetermined gesture information and corresponding functions, and the corresponding functions may include a function to switch accounts, a function to remove ice and open a door, a function to turn off starting of the vehicle from an outside of the vehicle, and a function to turn on the vehicle's external display.

The predetermined range of the vehicle may be a predetermined distance range between a user and a front, a rear, a left, or a right side of the vehicle, and the predetermined distance may be set within a range of 1 meter to 2 meters.

The vehicle control system may further include a mood light controller, wherein the mood light controller may be communicatively connected to the main control device, and the main control device may be further configured to turn on the mood light disposed outside the vehicle while determining whether the user's gesture is recognized within a predetermined range of the vehicle.

The main control device may be further configured to determine, when the execution of the corresponding function is completed, whether the execution of the corresponding function is successful, and to operate the mood light controller to provide the execution result to the user as feedback.

The main control device may be further configured to set the mood light disposed outside the vehicle to blink M times when the execution of the corresponding function is determined to be successful, and set the mood light disposed outside the vehicle to blink N times when the execution of the corresponding function is determined to be unsuccessful. M may be set to be different from N.

The vehicle control system may further include a remote control for wirelessly communicating with the main control device, wherein the main control device may be further configured to operate the mood light controller to provide the execution result as feedback and determines whether the car key exists within the predetermined range of the vehicle, and transmit the execution result to the remote control when it is determined that the car key does not exist within the predetermined range of the vehicle.

Each of the plurality of radars may be a four-dimensional (4D) millimeter-wave radar, and the number of the plurality of radars may be four, and the four radars may be disposed on a left front door, a right front door, a left rear door, and a right rear door of the vehicle, respectively.

A communicable connection may include a connection by a wired communication.

The wired communication may include a controller area network, a universal serial bus, a high-definition multimedia interface, and a digital video interface.

Another example embodiment of the present disclosure provides a vehicle control method. The method may include, by the radar, collecting a radar signal within the predetermined range around the vehicle and recognizing the user's gesture based on the received radar signal. The method may include, by a main control device, determining whether the main control device has recognized the user's gesture within the predetermined range of the vehicle when the vehicle is unattended; determining the corresponding function based on the recognized user's gesture; executing the determined corresponding function; and providing an execution result to the user as feedback.

The method may include, by the main control device, detecting whether the vehicle is unlocked; determining that the vehicle is unattended when it is detected that the vehicle is unlocked; detecting whether a car key exists within the predetermined range of the vehicle; detecting whether a gear of the vehicle is a neutral gear N or a parking gear P; and when it is determined that the vehicle is unattended, the car key exists within the predetermined range of the vehicle, and the gear of the vehicle is the neutral gear N or the parking gear P, determining whether the user's gesture is recognized within the predetermined range of the vehicle.

The method may further include storing a mapping table including predetermined gesture information and corresponding functions by a storage device and determining the corresponding function based on the recognized user's gesture according to the mapping table including predetermined gesture information and corresponding functions by the main control device, wherein the corresponding functions may include a function to switch accounts, a function to remove ice and open a door, a function to turn off starting of the vehicle from outside of the vehicle, and a function to turn on the vehicle's external display.

The predetermined range of the vehicle may be a predetermined distance range between a user and a front, a rear, a left, or a right side of the vehicle, and the predetermined distance may be set within a range of 1 meter to 2 meters.

The method may further include turning on the mood light disposed outside the vehicle by the main control device while determining whether the user's gesture is recognized within the predetermined range of the vehicle.

The method may further include, when the corresponding function is completed, determining by the main control device whether execution of the corresponding function was successful, then operating the mood light controller, and providing the execution result to the user as feedback by the main control device.

The method may further include setting the mood light disposed outside the vehicle to blink M times by the main control device when it is determined that the execution of the corresponding function is successful, and setting the mood light disposed outside the vehicle to blink N times by the main control device when it is determined that the execution of the corresponding function is unsuccessful, wherein M may be set to be different from N.

The method may further include providing the execution result as feedback by operating the mood light controller, and determining whether a car key exists within the predetermined range of the vehicle by the main control device; and transmitting the execution result to the remote control by the main control device when it is determined that the car key does not exist within the predetermined range of the vehicle.

According to an example embodiment of the present disclosure, interaction with users outside the vehicle may be enhanced through gesture recognition by measuring the distance and recognizing the images using a millimeter-wave radar. The probability of failure may be reduced, and the interactive experience and convenience of the user outside the vehicle may be improved. Additionally, according to an example embodiment of the present disclosure, various functions are included to respond to more usage situations, including, but not limited to, the following functions.

User account switching function: Before the user gets in, the vehicle settings may be quickly configured to suit the user's needs; for example, positions of a seat and a rearview mirror may be pre-adjusted according to the user's account memory. Therefore, the user may switch the account memory after getting in, and the problem of the seat being pushed too far forward (or backward) or the user having insufficient leg space due to different accounts may be overcome. Additionally, it may ensure an appropriate door opening angle when the user opens the door. The user account switching function may reduce the number of complex adjustments that users need to make after getting in, thereby improving the overall vehicle usage experience.

Ice-breaking and door-open function: In extremely cold weather, when the door cannot be opened due to freezing or damage to the built-in or button-type door handle, the user may quickly open the door by directly triggering the ice-breaking and door-open function through a gesture. Therefore, the user experience is optimized by reducing the time users spend waiting in extremely cold weather.

Function for turning off the vehicle from outside of the vehicle: If the user finds that the vehicle's ignition is not turned off after getting out of the vehicle (e.g., the engine is not turned OFF or the power is not turned OFF), the system recognizes gestures from outside of the vehicle to enable the user to turn off the vehicle's ignition without having to get inside the vehicle, particularly when it is raining, very cold, or the user has items in his or her hands. Accordingly, the user experience is greatly improved.

Function for turning on the vehicle's external display: The vehicle's external display function may include music and lighting displays, etc., and the vehicle's external display function may reinforce the interaction between the user and the vehicle, improving the entertainment experience of using the vehicle.

In summary, the example embodiments of the present disclosure may not only improve the interactive experience and convenience between the user and the vehicle outside the vehicle through the user gesture recognition function implemented using the millimeter-wave radar, but may also improve the level of vehicle intelligence and the user's satisfaction.

In addition, any effects that may be obtained or expected from the example embodiments of the present disclosure are disclosed directly or implicitly in the detailed description of the example embodiments of the present disclosure. That is, various effects expected according to the example embodiments of the present disclosure will be disclosed in the following detailed description.

### BRIEF DESCRIPTION OF THE FIGURES

Example embodiments of the present disclosure will be described in detail with reference to accompanying drawings. For clarity, identical members in different drawings are represented by the same reference numerals. It should be noted that the drawings are for illustrative purposes only and may not be drawn to scale.

FIG. 1 is a block diagram illustrating a vehicle control system according to an example embodiment of the present disclosure.

FIG. 2 is a flowchart illustrating a vehicle control method according to an example embodiment of the present disclosure.

FIG. 3 is a flowchart illustrating a vehicle control method according to an example embodiment of the present disclosure.

### DETAILED DESCRIPTION

Hereinafter, example embodiments of the present disclosure will be described in detail, and the present example embodiments are implemented based on the technical solution of the present disclosure. Detailed example embodiments and a specific operating process are disclosed, but the scope of the present disclosure is not limited to the following example embodiments.

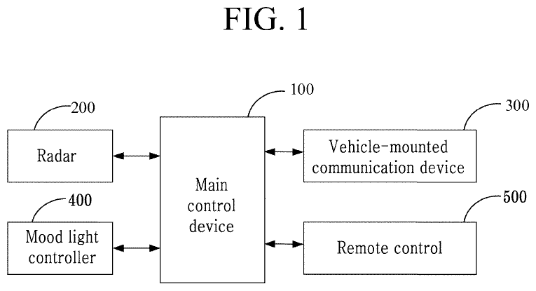

Hereinafter, example embodiments of the present disclosure will be described in detail with reference to the attached drawings. FIG. 1 is a block diagram illustrating a vehicle control system according to an example embodiment of the present disclosure. Referring to FIG. 1, the vehicle control system may include: a main control device 100, a radar 200, and a vehicle-mounted communication device 300.

The radar 200 may include a radar processing module and radars. The radars are connected to the radar processing module to communicate with each other, and the radars collect radar signals within a predetermined range around a vehicle and transmit the received radar signals to the radar processing module. The radar processing module recognizes the user's gesture based on the received radar signals.

The number of radars may be three, four, five, six, or more. According to an example embodiment of the present disclosure, the number of radars may be four, and the radars may be installed on a left front door, a right front door, a left rear door, and a right rear door of the vehicle, respectively. According to an example embodiment of the present disclosure, the arrangement and number of the radars are not limited thereto, and the radars may be arranged in various positions according to the vehicle structure and actual needs.

In a gesture recognition process, a radar distance-measuring function and a point-cloud signal gesture recognition algorithm may be combined. Specifically, information on the position and distance of the user's hand may be determined using the distance-measuring function, and a three-dimensional (3D) image of the user's hand may be constructed using the point-cloud signal gesture recognition algorithm. In this way, movements and changes in the user's hand may be captured more accurately, thereby improving the accuracy of gesture recognition. At the same time, the radar may use millimeter-wave signals, and the millimeter-wave signals are not affected by sunlight and/or weather conditions, so they may maintain relatively high reliability across various environments.

According to an example embodiment of the present disclosure, the radar may be a millimeter-wave radar, and the millimeter-wave radar may be a four-dimensional millimeter-wave radar. The four-dimensional millimeter-wave radar is an upgraded version of a conventional three-dimensional millimeter-wave radar. Compared with the conventional three-dimensional millimeter-wave radar, the four-dimensional millimeter-wave radar offers improved angular resolution, speed resolution, and distance resolution. In particular, the four-dimensional millimeter-wave radar has improved altitude detection by achieving sub-degree angular resolution and has provided four-dimensional information on speed, distance, horizontal angle, and vertical altitude. The four-dimensional millimeter-wave radar detects the moving speed of a target using the Doppler effect, determines the distance by calculating the frequency difference between the emitted signal and the echo, and calculates the azimuth using the phase angle measurement principle.

The four-dimensional millimeter-wave radar and point-cloud signal gesture recognition method may realize accurate gesture recognition by capturing dynamic characteristics of the user's hand motion, and in detail, it may specifically include: emitting a frequency modulated continuous wave (FMCW) using a four-dimensional millimeter-wave radar, processing the received echo signal, and forming point-cloud data including distance, speed, and angle information. The method may include extracting important features such as weighted Doppler, instantaneous energy, weighted range, horizontal angle, pitch angle, etc., from the point-cloud data. The characteristic may reflect the speed, position, and direction of the user's hand motion. Different gestures are recognized by analyzing changes in the trends of the features. By optimizing and tailoring the algorithm to specific application needs, the accuracy and efficiency of recognition may be improved.

The main control device 100 may be connected to the radar 200 and the vehicle-mounted communication device 300 to facilitate communication. According to an example embodiment of the present disclosure, the main control device 100 may be a body domain controller (BDC). The main control device 100 is connected to the central control unit (CCU) so that it may communicate with the CCU and may obtain vehicle status information (e.g., whether a vehicle is unlocked, whether a car key is within a predetermined range around the vehicle, whether the vehicle is in a neutral gear N or a parking gear P, whether a mood light on the outside of a door is on) from the CCU. The main control device 100 may additionally be configured to acquire user gesture information within a predetermined range of the vehicle when the vehicle is unattended, and to realize a corresponding function based on the acquired gesture information.

The main control device 100 may include a processor or a microprocessor (MCU). The main control device 100 may further include a memory, selectively. The operation or function of the main control device 100 may be realized by computer-readable code, algorithm, or software stored in the memory, and the memory may include a nonvolatile computer-readable recording medium. The nonvolatile computer-readable recording medium may be any data storage medium for storing data read by a processor or a microprocessor. Examples of the computer-readable recording media include a hard disk drive (HDD), a solid-state drive (SSD), a silicon disk drive (SDD), a read-only memory (ROM), a random access memory (RAM), a CD-ROM, a magnetic memory, a floppy disk, and an optical data storage device. The processor or the microprocessor may perform the operation or function of the vehicle-mounted control device by executing computer-readable code, algorithm, or software stored on the nonvolatile computer-readable recording medium.

According to an example embodiment of the present disclosure, the storage device stores a mapping table including predetermined gesture information and corresponding functions. Corresponding functions may include a function for switching accounts, a function for opening a door by breaking the ice, a function for turning off the vehicle's starting on the outside of the vehicle, a function for turning on the vehicle's exterior display, etc. The above-noted functions are only examples, and an example embodiment of the present disclosure is not limited to the functions.

The function for switching accounts may control the positions of seats, rearview mirrors, steering wheels, etc., as well as whether the air conditioner is operating and whether the mood light is turned on, according to different account settings. The function for switching accounts allows users to pre-adjust the vehicle based on predetermined account information before getting in, thereby improving the user's riding experience to suit the individual needs of different users.

The function for breaking the ice to open the door solves the problem of embedded or button-type door handles not being able to open due to freezing or damage caused by extreme cold, thereby reducing the time the user has to wait in extreme cold and optimizing the user experience.

The function to turn off the vehicle's ignition from the outside of the vehicle may solve the problem of the user getting out of the vehicle and discovering that the vehicle's ignition is not turned off (e.g., the engine is not turned OFF, or the power is not turned OFF). The vehicle's starting button is usually located near the armrest box, so the user must bend down and get inside the vehicle to turn off the vehicle's ignition. Particularly if the user has to open the door again and turn off the vehicle starting when it rains, it is very cold, or they have an item in their hand, this is not a good user experience. Therefore, if the user can turn off the vehicle from the outside of the vehicle, his or her experience will be further optimized.

The function for turning on the vehicle's external display may include a function such as music and light displays, and may provide a richer interactive experience to the user.

To realize the above-noted function, the vehicle control system according to an example embodiment of the present disclosure may further include a seat controller, a door controller, a power domain controller, a vehicle entertainment domain controller, and a mood light controller 400.

The controller may be connected to the main control device so that they may communicate with each other. The seat controller may control and adjust various functions, such as heating, ventilation, massage, and seat position adjustment of the vehicle. The door controller may manage the opening and closing, locking, and unlocking functions of the door. The power domain controller may manage and control the vehicle's power system, such as the engine, motor, transmission, and battery management system. The vehicle entertainment domain controller may provide multimedia entertainment functions such as a navigation system, an audio system, video playback, and an Internet connection. The mood light controller 400 may control the ON and OFF of the mood lights inside and outside the vehicle, thereby improving the visual effect and recognizability of the vehicle.

The vehicle control system may further include a remote control 500. The remote control 500 may be connected to the vehicle-mounted communication device so that they can communicate with each other, and the remote control 500 may receive the execution result of the function triggered by the user's gesture and may allow the user to immediately confirm it. The remote control 500 may include devices such as a mobile phone, a laptop, a desktop, or a tablet PC.

According to an example embodiment of the present disclosure, a communicable connection may be a connection via wired communication and/or wireless communication. The wired communication methods may include a controller area network (CAN), a local interconnect network (LIN), a universal serial bus (USB), a high-definition multimedia interface (HDMI), and a digital visual interface (DVI). Here, the CAN may include a power train CAN bus (P_CAN), a vehicle body control device CAN bus (B_CAN), a chassis control CAN bus (C_CAN), etc., but the CAN communication method is not limited to the above-described CAN bus communication method. The wireless communication methods may include global mobile communication systems, code division multiple access, wideband code division multiple access, universal mobile communication systems, time-division multiple access, and long-term evolution.

The non-contact interactive method of the vehicle control system, according to an example embodiment of the present disclosure, not only improves driving convenience but also provides a more personalized driving experience for the user.

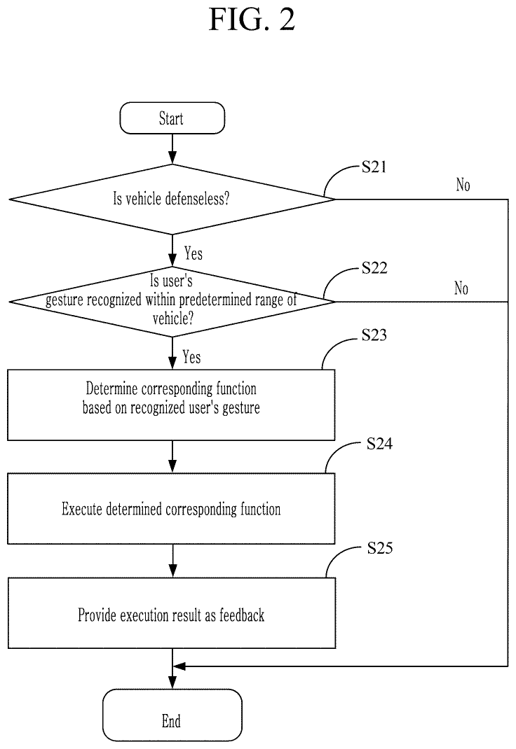

FIG. 2 is a flowchart illustrating a vehicle control method according to an example embodiment of the present disclosure. Referring to FIG. 2, it is determined whether the vehicle is unattended (S21). Determining whether the vehicle is unattended may include, but is not limited to, detecting whether the vehicle is unlocked.

According to an example embodiment of the present disclosure, for safety reasons, it is possible to additionally detect whether the car key is present within the predetermined range of the vehicle and whether the vehicle is in a neutral gear (neutral gear N) or a parking gear (parking gear P).

Detecting whether the vehicle is unlocked is performed by checking the door-locked status, car key status, or other safety system status. Detecting whether the car key is present within the predetermined range of the vehicle may include detecting whether the car key is present within the predetermined range of a vehicle using wireless communication technology (e.g., UWB, Bluetooth). Detecting whether the vehicle's gear is neutral gear N or parking gear P is performed by detecting the vehicle's status to ensure the vehicle's stationary state.

The detecting of whether a vehicle is unlocked, detecting of whether a car key is present within a predetermined range of the vehicle, detecting of whether a mobile device is present within a predetermined range of the vehicle and determining of whether the detected mobile device is authorized, and detecting of whether the vehicle's gear is the neutral gear N or the parking gear P are known techniques in the relevant fields, so their descriptions will be omitted in the present specification.

When the vehicle is determined to be unattended, it is determined whether the user's gesture is recognized within a predetermined range of the vehicle (S22).

According to an example embodiment of the present disclosure, the predetermined range of the vehicle may be a distance range between the user and the front, rear, left, or right side of the vehicle. The front, rear, left, and right sides of the vehicle are generally defined according to the direction of the vehicle's head. That is, the direction in which the vehicle's head faces is the front of the vehicle, and it is also the direction in which the driver looks when sitting in the driver's seat. The direction opposite to the direction in which the vehicle's head faces is the rear direction of the vehicle. When viewed from the angle at which the driver sits, the direction of the driver's left hand is the left side of the vehicle, and the direction of the driver's right hand is the right side of the vehicle.

The vehicle's predetermined range may be set to be a region where the distance between the user and the front, rear, left, or right of the vehicle is less than a predetermined distance. The specified distance may be set within the range of 1 meter to 2 meters. The definition of the predetermined range of the vehicle is an example, and an example embodiment of the present disclosure is not limited thereto.

The vehicle control method, according to an example embodiment of the present disclosure, may turn on the mood light on the outside of the door while determining whether the user's gesture is recognized within the predetermined range of the vehicle. Turning on the mood light not only improves visibility of the vehicle but also provides a function for intuitively notifying the user that the gesture recognition function has been triggered.

Mood lighting on the outside of the door is usually installed in areas such as the external handle of the door and the bottom of the door. The specific mounting position of the mood light on the outside of the door may vary depending on the vehicle model and configuration. Some vehicle models offer more mood lighting options and customized lighting designs to meet the needs of different users.

The vehicle control method according to an example embodiment of the present disclosure may improve the convenience of the user's operation by combining gesture recognition technology and application of the mood light outside the door, and may further improve the stability of gesture recognition at night or in dimly lit conditions so that the user may interact with the vehicle more easily.

A corresponding function is determined based on the recognized user's gesture (S23). Step (S23) relates to recognizing the user's gesture and mapping it to a corresponding function or instruction. The storage device stores a mapping table including predetermined gesture images and corresponding functions, as shown in Table 1. Table 1 is an example, and more functions may be realized by setting more gestures and combinations of different gestures.

TABLE 1

| Gesture | |
|---|---|
| images | Functions |
| [symbol] | Function to switch accounts |
| [symbol] | Function to break the ice and open the door |
| [symbol] | Function to turn off the vehicle's ignition |
| [symbol] | from the outside of the vehicle |
| | Function to turn on the vehicle's external display |

The determined corresponding function is executed (S24). Once the function that the user wants is determined, the determined function may be executed. This may include calling other parts of the system or interacting with external devices or servers.

When it is determined to execute the function to switch accounts, the main control device 100 requests account memory information from the vehicle entertainment domain controller, the vehicle entertainment domain controller transmits the account memory information to the main control device 100, and the main control device 100 operates the seat controller, the rearview mirror controller, the steering wheel controller, etc. according to the account memory information. For example, the main control device 100 adjusts the seat to a specified position, adjusts the rearview mirror by a specified angle, and adjusts the steering wheel to a specified position. The account memory information may further include seat ventilation and heating, HUD angle, and mood lighting color, depending on the user's preferences.

When it is determined to execute the function to break the ice and open the door, the main control device 100 transmits a door-open instruction to the door controller, and the door controller receives the door-open instruction and opens the door.

When it is determined to execute the function to turn off the vehicle's ignition from the outside of the vehicle, the main control device 100 may determine whether there is a person in the seat, and if it is determined that there is a person in the seat, it may determine that the operation of the function has failed. When it is determined that no one is in the seat, the main control device 100 may transmit an engine OFF request to the power domain controller, thereby turning off the vehicle's ignition.

When it is determined to execute the function to turn on the vehicle's external display, the main control device 100 asks the vehicle entertainment domain controller to enter the vehicle external display memory mode, and the vehicle entertainment domain controller receives the request, plays music, and adjusts the mood light. The main control device 100 operates the door controller, the window controller, the rearview mirror controller, the headlight controller, and the taillight controller according to the vehicle's external display memory mode.

Gestures may be set to turn off the vehicle's exterior display functions, and combinations of different gestures may be set to turn ON or OFF different vehicle lights, and door and rearview mirror lights.

An execution result is provided to the user as feedback (S25). The vehicle control method according to the present disclosure may provide feedback to the user to inform the user whether the requested function has been executed. That is, feedback results may be provided to the user in ways such as visual and auditory.

According to an example embodiment of the present disclosure, by measuring a distance and recognizing images using a millimeter-wave radar, the gesture recognition function may be enhanced, failure probability may be reduced, and responses may be made to more usage situations. This may help improve the user's experience outside the vehicle and increase the vehicle's intelligence level and the user's satisfaction.

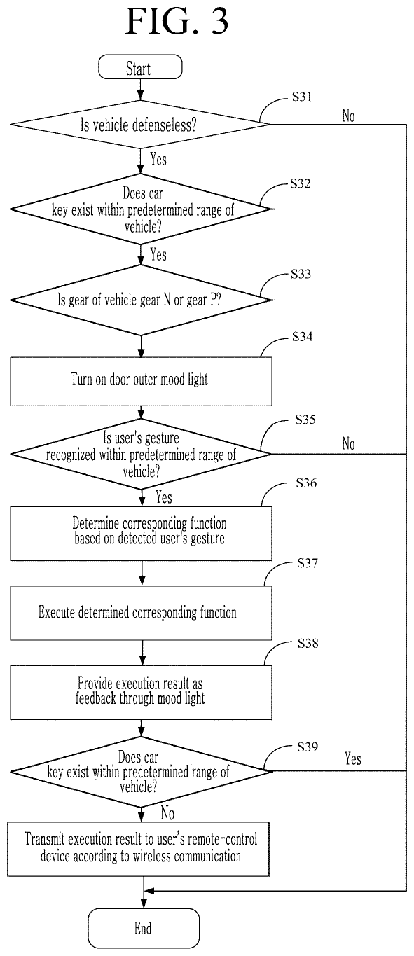

A workflow of a vehicle control method according to an example embodiment of the present disclosure will now be described in detail with reference to FIG. 3.

Referring to FIG. 3, it is determined by the main control device 100 whether the vehicle is unattended (S31). It is detected by the main control device 100 whether the vehicle is unlocked. It is detected by the main control device 100 whether the car key exists within the predetermined range of the vehicle (S32). It is detected by the main control device whether the vehicle's gear is the neutral gear N or the parking gear P (S33).

When the vehicle is unlocked, the car key is present within the predetermined range of the vehicle, and the vehicle is determined to be in the neutral gear N or the parking gear P (i.e., “Yes” in S31, “Yes” in S32, and “Yes” in S33), the door outer mood light is turned on (S34). That is, when the above-noted three conditions are satisfied (the vehicle is already unlocked, a valid car key is present, and the vehicle is in the neutral gear N or the parking gear P), the mood light on the outside of the door may be turned on. This may provide visual feedback to the user and may indicate that the vehicle is ready to provide a gesture recognition function.

It is determined whether the user's gesture is recognized within the predetermined range of the vehicle by the main control device 100 (S35). The user's gesture is recognized within the predetermined range of the vehicle using the radar 200, and the recognized user's gesture is transmitted to the main control device 100.

A corresponding function is determined based on the user's gesture recognized by the main control device 100 (S36). When the user's gesture is recognized, the main control device 100 may determine the function desired by the user based on a predefined gesture-function mapping table.

The determined corresponding function is executed (S37). The main control device 100 may execute the function determined in S36, which may relate to various systems of the vehicle, such as the audio system, the navigation system, and the air conditioning system.

A method for executing the determined corresponding function will now be described by exemplifying that the determined corresponding function is the function for turning off the vehicle's ignition from the outside of the vehicle. When it is determined to execute the function to turn off the vehicle's ignition from the outside of the vehicle, the main control device 100 determines whether a person is in the seat based on the detection result of the seat detection device. When it is determined that a person is in the seat, the main control device 100 determines that the operation of the function to turn off the vehicle ignition from the outside of the vehicle has failed. When it is determined that no one is in the seat, the main control device 100 transmits an engine OFF request to the power domain controller to turn the engine OFF and determines that the operation of the function to turn off the vehicle's ignition from the outside of the vehicle has been successful.

The execution result is provided as feedback through the mood light on the outside of the door (S38). When the execution of the corresponding function is finished, the main control device 100 may determine whether the execution of the corresponding function has been successful and may operate the mood light controller 400 to provide feedback on the execution result.

When the execution of the corresponding function is determined to have been successful, the mood light outside the door is set to blink M times, and when the execution of the corresponding function is determined to have been unsuccessful, the mood light outside the door is set to blink N times, where M may be set to 1 and N may be set to 2. This is an example, and an example embodiment of the present disclosure is not limited to this feedback method.

The main control device 100 additionally determines whether the car key is within the predetermined range of the vehicle (S39). When it is determined that the car key is not within the predetermined range of the vehicle, the execution result is transmitted to the user's remote control 500 through the vehicle-mounted communication device 300 by the main control device 100. That is, when the system detects that the car key is not within the predetermined range of the vehicle, it may transmit the execution result to the user's remote control (e.g., a smartphone or a laptop) via wireless communication (e.g., a cellular network or Wi-Fi). In this way, the user may receive notifications about vehicle states and important events from remote location.

The vehicle control system and method according to an example embodiment of the present disclosure may recognize the user's position using the vehicle's radar, may recognize specific gestures of the user using a point-cloud signal gesture recognition method, and may realize the function response in a non-contact manner when the vehicle is unattended.

The various example embodiments of the present disclosure do not enumerate every possible combination, but rather illustrate representative examples of the present disclosure. Additionally, the content described in various example embodiments may be applied independently or in combinations of two or more.

While this disclosure has been described in connection with what is presently considered to be practical example embodiments, it is to be understood that the disclosure is not limited to the disclosed example embodiments.

1. A vehicle control system comprising:
a radar; and
a main control device;
wherein the radar comprises a radar processing module and a plurality of radars, the radar processing module being communicatively connected to each of the plurality of radars;
wherein the plurality of radars are configured to collect radar signals within a predetermined range around a vehicle, and to transmit the collected radar signals to the radar processing module, and the radar processing module is configured to recognize a user's gesture based on the collected radar signals;
wherein the main control device is communicatively connected to the radar; and
wherein, when the vehicle is unattended, the main control device is configured to:
determine whether the user's gesture is recognized within the predetermined range of the vehicle;
determine a corresponding function based on the user's gesture;
execute the corresponding function; and
provide an execution result to the user as feedback.

2. The vehicle control system of claim 1, wherein the main control device is further configured to:
detect whether the vehicle is unlocked;
determine that the vehicle is unattended when the vehicle is detected as unlocked;
detect whether a car key exists within the predetermined range of the vehicle;
detect whether a gear of the vehicle is set to neutral gear or a parking gear; and
determine whether the user's gesture is recognized within the predetermined range of the vehicle when the vehicle is unattended, whether the car key exists within the predetermined range of the vehicle, and whether the gear of the vehicle is set to the neutral gear or the parking gear.

3. The vehicle control system of claim 1, wherein:
the main control device comprises a storage device storing a mapping table including predetermined gesture information and corresponding functions;
the main control device is further configured to determine the corresponding function based on the user's gesture according to the mapping table; and
the corresponding functions include at least one of:
a function to switch user accounts;
a function to remove ice and open a door;
a function to turn off an ignition of the vehicle from outside the vehicle; and
a function to turn on an external display of the vehicle.

4. The vehicle control system of claim 1, wherein:
the predetermined range of the vehicle is defined as a predetermined distance range between a user and at least one of a front side, a rear side, a left side, or a right side of the vehicle; and
the predetermined distance is set to be within a range of 1 meter to 2 meters.

5. The vehicle control system of claim 1, further comprising a mood light controller communicatively connected to the main control device,
wherein the main control device is further configured to operate the mood light controller to turn on a mood light disposed outside the vehicle while determining whether the user's gesture is recognized within the predetermined range of the vehicle.

6. The vehicle control system of claim 5, wherein
the main control device is further configured to:
determine, upon completion of execution of the corresponding function, whether the execution has been successful; and
operate the mood light controller to provide the execution result to the user as feedback.

7. The vehicle control system of claim 6, wherein
the main control device is further configured to:
set the mood light disposed outside the vehicle to blink a first number of times when the execution of the corresponding function is determined to have been successful; and
set the mood light disposed outside the vehicle to blink a second number of times different from the first number of times when the execution of the corresponding function is determined to have been unsuccessful.

8. The vehicle control system of claim 6, further comprising a remote control configured to wirelessly communicate with the main control device,
wherein the main control device is further configured to:
operate the mood light controller to provide the execution result as feedback;
determine whether a car key exists within the predetermined range of the vehicle; and
transmit the execution result to the remote control when the car key is determined not to exist within the predetermined range of the vehicle.

9. The vehicle control system of claim 1, wherein:
each of the plurality of radars is a four-dimensional millimeter-wave radar; and
the plurality of radars includes a first radar positioned on a left front door, a second radar positioned a right front door, a third radar positioned on a left rear door, and a fourth radar positioned on a right rear door of the vehicle.

10. The vehicle control system of claim 1, wherein
a communicable connection includes a connection in a wired communication, and
the wired communication includes a controller area network, a universal serial bus, a high-definition multimedia interface, and a digital video interface.

11. A vehicle control method comprising:
collecting radar signals, by a radar, within a predetermined range around a vehicle,
recognizing, by the radar, a user's gesture based on collected radar signals;
determining, by a main control device, whether the user's gesture is recognized within the predetermined range of the vehicle when the vehicle is unattended;
determining, by the main control device, a corresponding function based on the user's gesture;
executing by the main control device, the corresponding function; and
providing by the main control device, an execution result to the user as feedback.

12. The vehicle control method of claim 11, further comprising:
detecting, by the main control device, whether the vehicle is unlocked;
determining, by the main control device, that the vehicle is unattended when the vehicle is detected as unlocked;
detecting, by the main control device, whether a car key exists within the predetermined range of the vehicle;
detecting, by the main control device, whether a gear of the vehicle is set to a neutral gear or a parking gear; and
when it is determined that the vehicle is unattended, the car key exists within the predetermined range of the vehicle, and the gear of the vehicle is set to the neutral gear or the parking gear, determining, by the main control device, whether the user's gesture is recognized within the predetermined range of the vehicle.

13. The vehicle control method of claim 11, further comprising:
storing, by a storage device, a mapping table including predetermined gesture information and corresponding functions; and
determining, by the main control device, the corresponding function based on the user's gesture according to the mapping table,
wherein the corresponding functions include at least one of:
switching user accounts;
removing ice and opening a door,
turning off an ignition of the vehicle from outside the vehicle; and
turning on an external display of the vehicle.

14. The vehicle control method of claim 11, wherein
the predetermined range of the vehicle is defined as a predetermined distance range between a user and at least one of a front side, a rear side, a left side, or a right side of the vehicle; and
the predetermined distance is set within a range of 1 meter to 2 meters.

15. The vehicle control method of claim 11, further comprising:
operating a mood light disposed outside the vehicle by the main control device while determining whether the user's gesture is recognized within the predetermined range of the vehicle.

16. The vehicle control method of claim 15, further comprising:
determining whether execution of the corresponding function has been successful by the main control device upon completing of execution of the corresponding function; and
providing the execution result to the user as feedback by operating a mood light controller.

17. The vehicle control method of claim 16, further comprising:
setting the mood light disposed outside the vehicle to blink a first number of times when execution of the corresponding function is determined to have been successful; and
setting the mood light disposed outside the vehicle to blink a second number of times different from the first number of times when execution of the corresponding function is determined to have been unsuccessful.

18. The vehicle control method of claim 16, further comprising:
determining whether a car key exists within the predetermined range of the vehicle; and
transmitting the execution result to a remote control when the car key is determined not to exist within the predetermined range of the vehicle.
